(19) United States
(12) Patent Application Publication
(10) Pub. No.: US 2016/0064975 A1
(43) Pub. Date: Mar. 3, 2016

(54) Wind Turbine Charging System

(71) Applicant: Gary Withee, Fairbanks, AK (US)

(72) Inventor: Gary Withee, Fairbanks, AK (US)

(21) Appl. No.: 14/121,402

(22) Filed: Sep. 2, 2014

(51) Int. Cl. H02J 7/00; F03D 9/00; H02J 7/14; F03D 1/04

(52) U.S. Cl. CPC H02J 7/0042; F03D 1/04; F03D 9/002; H02J 7/1415

(57) ABSTRACT

The Wind Turbine Charging System using existing technology to use wind resistance to propel blades that turn the gearing connected to the shafts which turn the generator or alternator fast enough to produce electricity to a battery pack on a vehicle of any type.

### BACKGROUND OF THE INVENTION

(1) Field of the Invention

The Wind Turbine Charging System has to do with using wind power to propel blades to produce electric power.

(2) Description of the Art Including Information Disclosed Under 37 CFR 1.97 & 1.98

The art described in the drawings of the design and utility function illustrate the unique ability of the Wind Turbine Charging System to use wind to power blades to produce electricity. We are not attempting to patent the concept of a wind turbine that has been used for decades with the large wind turbines that produce electricity now. This is a new concept with a unique design that allows it to be used on automobiles or boats or Recreational vehicles or aircraft. We have found no other patents that would conflict with our design and its functionality.

### BRIEF SUMMARY OF THE INVENTION

The Wind Turbine Charging System is a small self-contained device that can attach to any automobile whether electric or not or any boat, recreational vehicle or aircraft that can use added power delivered to the battery pack for the drive train of the vehicle or for the battery pack that powers accessories with the vehicle. It uses the wind resistance as the vehicle is moving to propel the blades and produce electricity to the battery pack with a generator or alternator.

### BRIEF DESCRIPTION OF THE SEVERAL VIEWS OF THE DRAWINGS

There are 7 drawings in total that describe and illustrate the design and function of the invention.

FIG. 1: is the ¾ view perspective of the entire device.

FIG. 2: is the front elevation view with the screen and blades showing.

FIG. 3: is the rear view elevation with internal shroud and screen and blades showing.

FIG. 4: is the exterior side view elevation.

FIG. 5: is the front interior view of the device.

FIG. 6: is the rear interior view of the device.

FIG. 7: is the exploded view of the device showing all of its parts.

### DETAILED DESCRIPTION OF THE PREFERRED EMBODIMENT

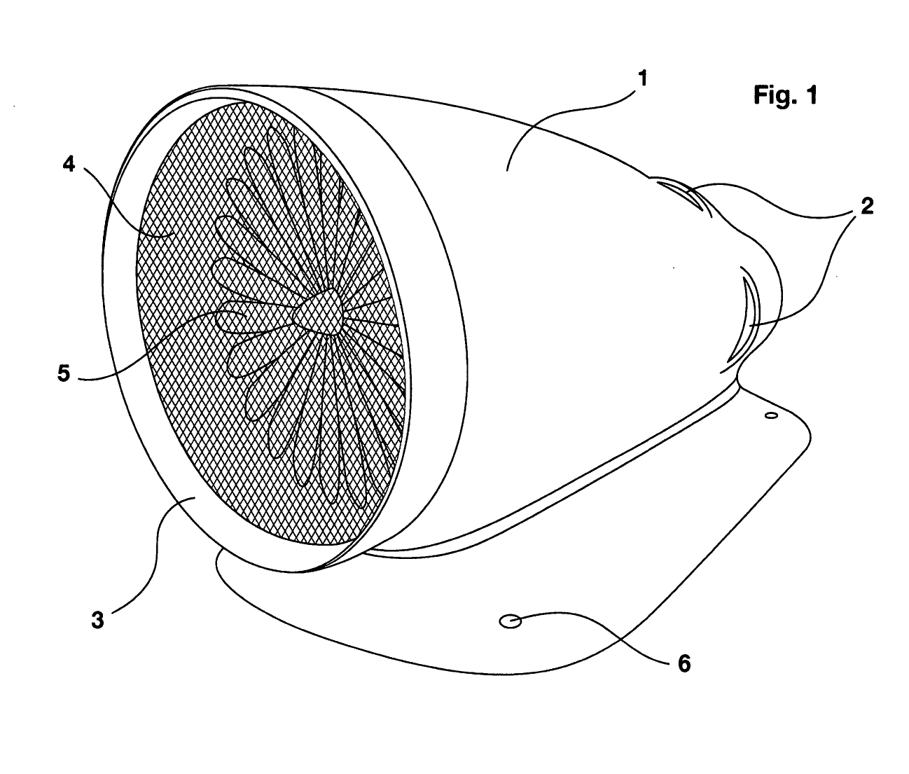

FIG. 1: In this ¾ view illustration #1 is the main body and outer shroud of the device with #2 the louver fins that catch the air flow to pull more air through the inner chamber with #3 the shroud cap that screws on and off to hold the #4 the screen in place of the front intake to repel bugs and such from entering the inner chamber with #5 the blades that catch the wind force and spin the shaft with #6 the mounting frame that attaches to any surface.

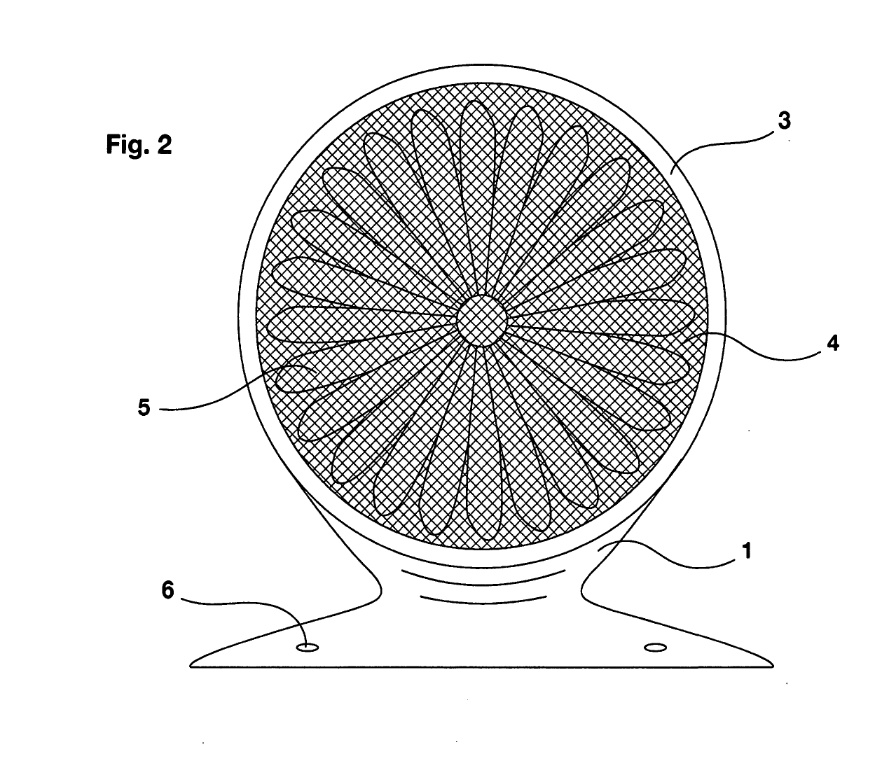

FIG. 2: In front view illustration #1 is the main body and outer shroud of the device with #3 the shroud cap that screws on and off to hold the #4 the screen in place of the front intake to repel bugs and such from entering the inner chamber with #5 the blades that catch the wind force and spin the shaft with #6 the mounting frame that attaches to any surface.

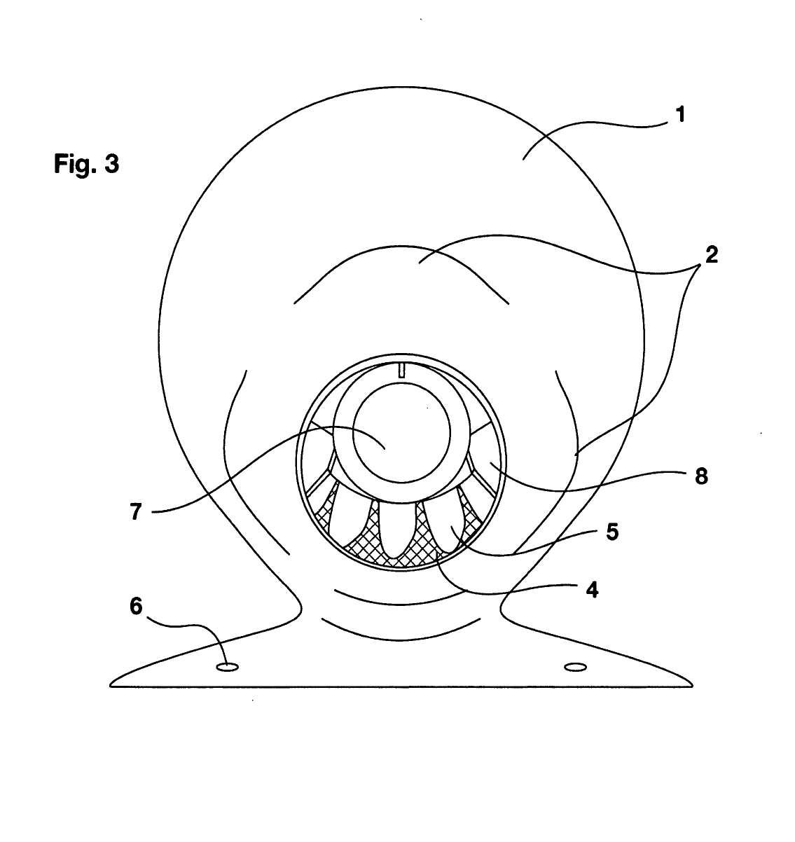

FIG. 3: In rear view illustration #1 is the main body and outer shroud of the device with #2 the louver fins that catch the air flow to pull more air through the inner chamber with #4 the screen in place of the front intake to repel bugs and such from entering the inner chamber with #5 the blades that catch the wind force and spin the shaft with #6 the mounting frame that attaches to any surface with #7 the inner shroud protecting the components inside and which is supported by #8 the inner support ribs connected to the inner and outer shroud.

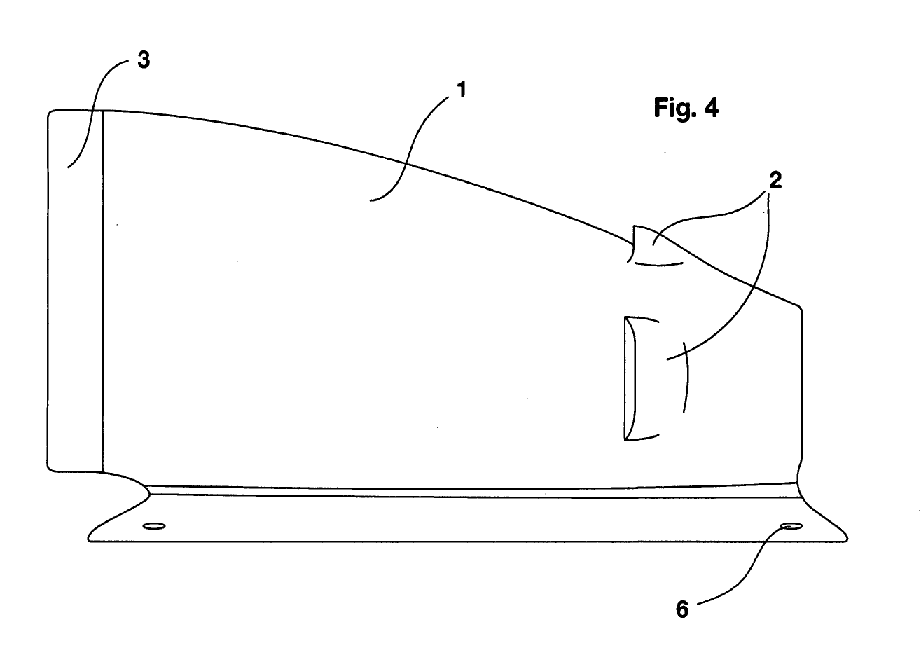

FIG. 4: In side view illustration #1 is the main body and outer shroud of the device with #2 the louver fins that catch the air flow to pull more air through the inner chamber with #3 the shroud cap that screws on and off with #6 the mounting frame that attaches to any surface.

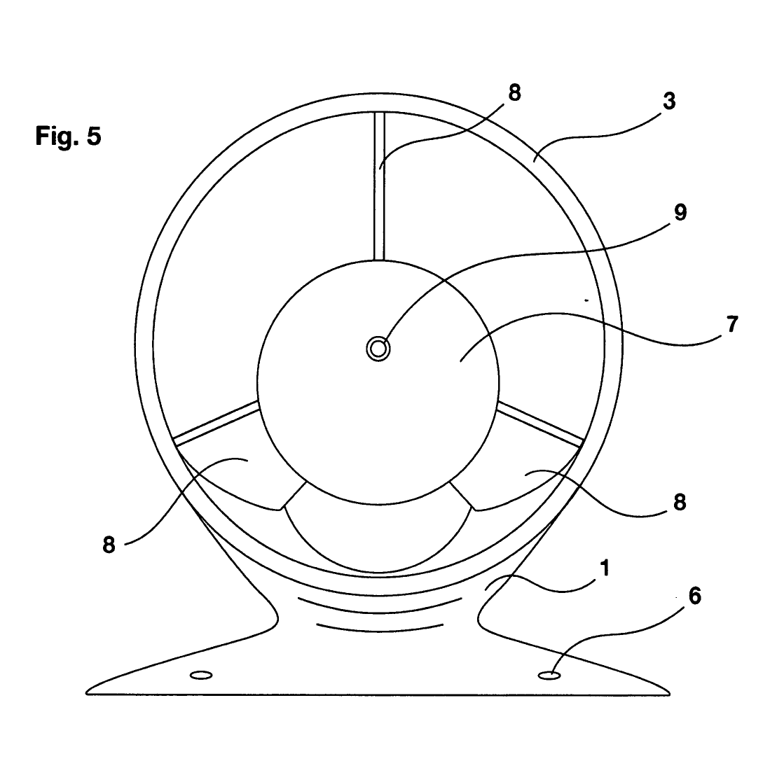

FIG. 5: In Illustration #1 is the main body and outer shroud of the device with #3 the shroud cap that screws on and off with #6 the mounting frame that attaches to any surface with #7 the inner shroud protecting the components inside and which is supported by #8 the inner support ribs connected to the inner and outer shroud with #9 the inner shroud propeller bearing.

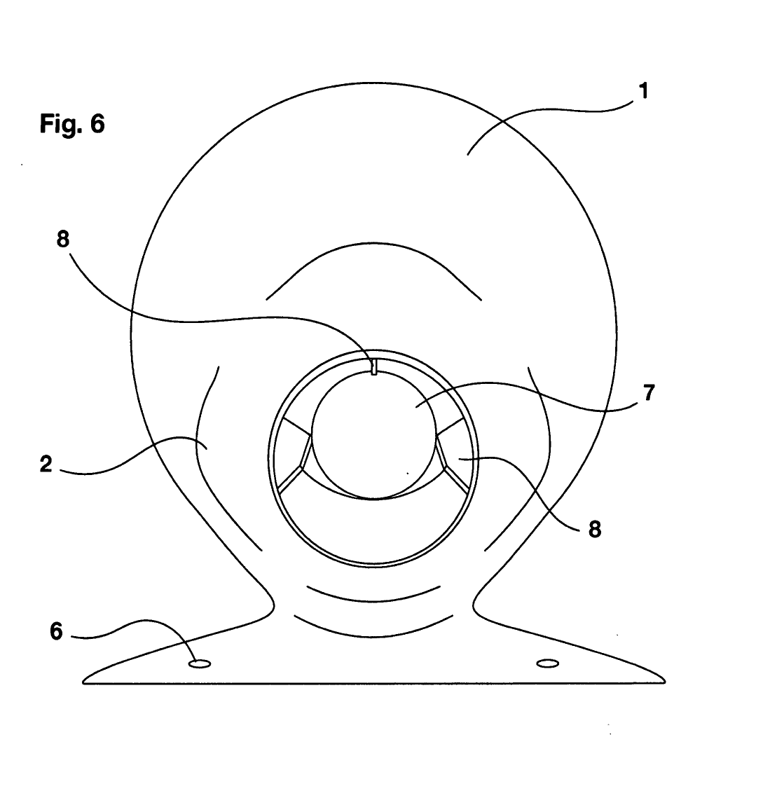

FIG. 6: In rear interior view Illustration #1 is the main body and outer shroud of the device with #2 the louver fins that catch the air flow to pull more air through the inner chamber with #6 the mounting frame that attaches to any surface with #7 the inner shroud protecting the components inside and which is supported by #8 the inner support ribs connected to the inner and outer shroud.

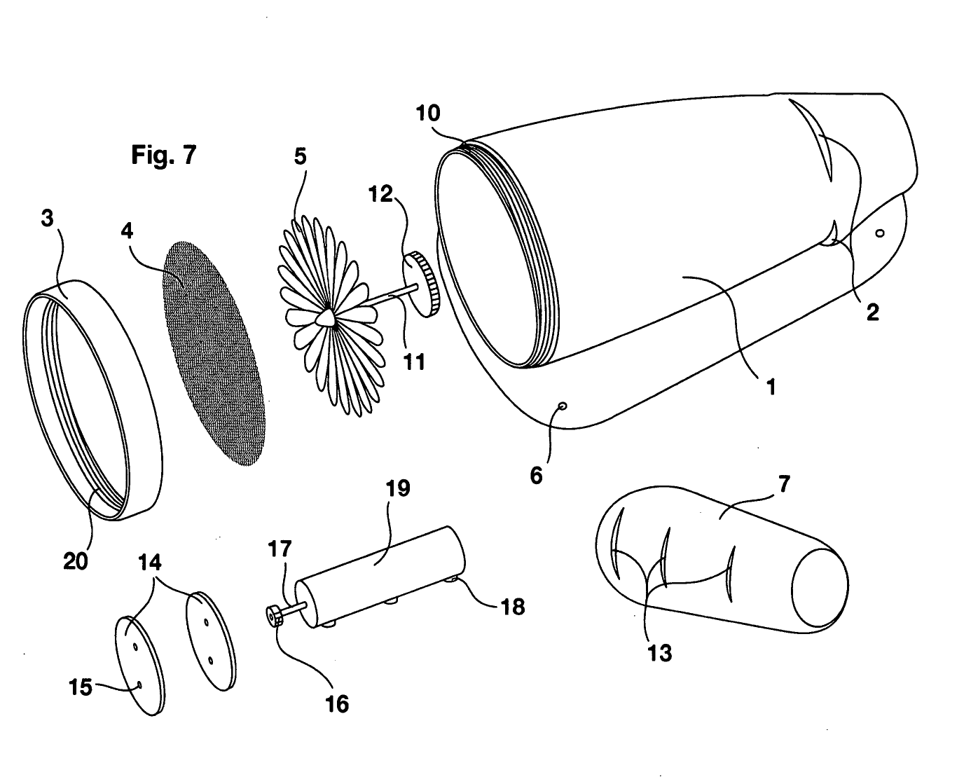

FIG. 7: In Illustration #1 is the main body and outer shroud of the device with #2 the louver fins that catch the air flow to pull more air through the inner chamber with #4 the screen in place of the front intake to repel bugs and such from entering the inner chamber with #5 the blades that catch the wind force and spin the shaft with #6 the mounting frame that attaches to any surface with #7 the inner shroud protecting the components inside and which is supported by #8 the inner support ribs connected to the inner and outer shroud with #9 the inner shroud propeller bearing with #10 the shroud cap threads with #11 the propeller shaft with #12 the propeller larger gear with #13 the inner shroud louvers that keep the generator or alternator cool during operation with #14 inner shroud support with #15 the inner shroud support bearings for the gear shafts with #16 the generator or alternator gear with #17 the generator or alternator shaft with #18 the generator or alternator feet that connect with the inner shroud for stability with #19 the generator or alternator with #20 the screen access shroud cap threads.

### Detailed Description of the Invention

The Wind Turbine Charging System is a unique charging system using the wind resistance to spin the blades with proper gearing to spin the shaft fast enough to produce electric energy with a generator or alternator. We are not attempting to patent the turbine concept as it has been patented years ago and has been used for decades with the giant wind turbines used now. We have developed a small self-contained device that can be attached to an electric automobile or recreational vehicle or boat or aircraft to generate enough electric power to charge a battery pack or battery bank to run an automobile or operate accessories. The design uses an existing concept that is public domain however has design that is unique to itself. It can be installed to any size or shape or texture of surface. It is designed to look like a jet turbine engine as it has the front intake area of a small size about 6 inches to 24 inches depending on the application. The intake has a screen for bug protection and such that protects the blades. The wind resistance moves the blades which in turn spin the shaft with the large gear. That shaft and gear then connect with the smaller gear on the generator or alternator. This is the same concept as the large wind turbines. As the generator spins it is spinning fast enough to produce a large amount of electric power for any purpose needed. The bearings are inside the supports for the shafts as seen in the drawings. There is an electrical cord connected that will connect to whatever or where ever it needs to be connected to which is usually a battery pack or battery bank. The Outer shroud is to create a wind chamber for the air coming to flow through the outer shroud and around an inner shroud. The inner shroud is sealed and contains the shafts, gearing, and the generator or alternator and the electric cord. The inner shroud is in the center of the outer shroud connected together with 3 support ribs holding the inner shroud in place and in the center of the outer shroud. On each side of the inner shroud are small louvers that allow the heat inside the inner shroud to expel and keeps the inner workings cool. In addition there are numerous louver fins on the outside of the outer shroud located in the rear ¾ location that allow air to flow into the inside rear portion to force more air to assist in pulling the blades and create more air moving through the entire wind chamber. All of this assists the blades to turn easier and faster to produce more energy for the battery pack or battery bank.

What is claimed is:

1. A wind turbine charging system comprising of:
a main body and outer shroud with a front air intake area of the device with louver fins located in the rear ¾ portion of the main body outer shroud that catch the air flow into the wind chamber to pull more air through the inner chamber allowing the blades to spin easier and faster to produce more electric power to a battery pack or battery bank;
a screen in the center placement of the front intake to repel bugs and such from entering the inner wind chamber;
a set of blades that catch the wind force and spin the shaft;
a mounting frame that attaches to any surface;
an inner shroud protecting the components inside and which is supported by the inner support ribs connected to the inner and outer shroud;
an inner shroud propeller bearing connected to the propeller shaft with the propeller larger gear;
a set of inner shroud louvers that keep the generator or alternator cool during operation;
an inner shroud support with the inner shroud support bearings for the gear shafts with the generator or alternator gear with the generator or alternator shaft with the generator or alternator feet that connect with the inner shroud for stability;
a screen access shroud cap with male threads and the outer shroud cap area with female threads.
